(19) United States
(12) Patent Application Publication
(10) Pub. No.: US 2018/0148898 A1
(43) Pub. Date: May 31, 2018

(54) ROAD STATE MANAGEMENT APPARATUS AND METHOD

(71) Applicant: FUJITSU LIMITED, Kawasaki-shi (JP)

(72) Inventors: Takashi Shimada, Shinagawa (JP); Tsutomu Ohta, Shinagawa (JP); Hiroshi Sasaki, Shinagawa (JP); Kosei Takano, Shinagawa (JP)

(73) Assignee: FUJITSU LIMITED, Kawasaki-shi (JP)

(21) Appl. No.: 15/792,188

(22) Filed: Oct. 24, 2017

(30) Foreign Application Priority Data
Nov. 25, 2016 (JP) 2016-229452

(51) Int. Cl. E01C 23/01; G01C 7/04; G06Q 50/08; G06K 9/00; G01B 21/30

(52) U.S. Cl. CPC E01C 23/01; G01C 7/04; B60W 2550/147; G06K 9/00791; G01B 21/30; G06Q 50/08

(57) ABSTRACT

A non-transitory computer-readable recording medium has stored therein a road state management program for causing a computer to execute a process, the process including receiving at least one information selected from the group including of information on a state of a surface of a road and information on a state under a surface of the road, distributing the received information to one or more management units of the road, and extracting the plurality of pieces of the distributed information so as to be in order of time, wherein each of the distributed information is common place of the road.

### CROSS-REFERENCE TO RELATED APPLICATION

This application is based upon and claims the benefit of priority of the prior Japanese Patent Application No. 2016-229452, filed on Nov. 25, 2016, the entire contents of which are incorporated herein by reference.

### FIELD

The embodiments discussed herein are related to a road state management apparatus and a road state management method.

### BACKGROUND

When to repair a road is decided based on measurement results of a state of the road, such as presence or absence of a crack of the road. It takes a lot of time, effort, and cost to measure the states of all the roads governed by a single municipality, and such measurement may be difficult in some regions.

Under such circumstances, a method of measuring a road state is proposed, which measures flatness of a road in a simple manner to select sites having poor measurement results, thereby reducing the number of sites to be subjected to detailed road state measurement which needs a lot of time, cost, etc. (see, for example, Japanese Laid-open Patent Publication No. 2015-176540).

### SUMMARY

According to one aspect of the present disclosure, a non-transitory computer-readable recording medium has stored therein a road state management program for causing a computer to execute a process including receiving at least one information selected from the group including of information on a state of a surface of a road and information on a state under the surface of the road, distributing the received information to one or more management units of the road, and extracting the plurality of pieces of the distributed information so as to be in order of time, wherein each of the distributed information is common place of the road.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a system including a road state management apparatus according to an embodiment disclosed herein;

FIG. 2 is a diagram illustrating an example of a function configuration of a road state management apparatus;

FIG. 3 is a schematic diagram illustrating an example of setting management units on a road map;

FIG. 4 is a diagram illustrating an example in which an extraction part distributes various kinds of information to management units;

FIG. 5 is a diagram illustrating an example of an image distributing various kinds of information to management units and displaying distributed information in order of time;

FIG. 6 a diagram illustrating an example of a table displaying calculation results of DII in order of time;

FIG. 7 is a diagram illustrating an example of a hardware configuration of a portable terminal;

FIG. 8 is a diagram illustrating an example of a function configuration of a portable terminal;

FIG. 9 is a diagram illustrating an example of a table of acceleration information stored in an acceleration information DB;

FIG. 10 is a diagram illustrating an example of a hardware configuration of a road surface condition measurement apparatus;

FIG. 11 is a diagram illustrating an example of a function configuration of a road surface condition measurement apparatus;

FIG. 12 is a diagram illustrating an example of crack information stored in a crack information DB;

FIG. 13 is a diagram illustrating an example of cavity information on a cavity under a surface of a road stored in a cavity information DB;

FIG. 14 is a diagram illustrating an example of a hardware configuration of a driving monitor apparatus;

FIG. 15 is a diagram illustrating an example of a function configuration of a driving monitor apparatus;

FIG. 16 is a diagram illustrating an example of driving information stored in a driving information DB;

FIG. 17 is a diagram illustrating an example of a hardware configuration of a road state management apparatus;

FIG. 18 is a diagram illustrating an example of a function configuration of a road state management apparatus;

FIG. 19 is a diagram illustrating an example of management unit information stored in a management unit DB;

FIG. 20 is a schematic diagram illustrating an example of setting management units on a road map;

FIG. 21 is a diagram illustrating an example of adjunct information stored in an adjunct information DB;

FIG. 22 is a diagram illustrating an example of infra facility information stored in an infra facility information DB;

FIG. 23 is a diagram illustrating an example of road sign information stored in a road sign information DB;

FIG. 24 is a diagram illustrating an example of repair history information stored in a repair history information DB;

FIG. 25 is a diagram illustrating an example of a basic information DB;

FIG. 26 is a diagram illustrating an example of a method for determining position information of a latitude and a longitude from position information from each predetermined distance unit;

FIG. 27 is a diagram illustrating an example in which an extraction part distributes various kinds of information to management units and extracts distributed information in order of time;

FIG. 28 is a diagram illustrating an example of a calculation method of DII;

FIG. 29 is a flowchart illustrating an example of a flow in which a display control part performs control for displaying, on a road on a road map, information on a state of a surface of a road or information on a state under the surface of the road in a management unit;

FIG. 30 is a diagram illustrating an example of a screen displaying information on a state of a surface of a road or information on a state under the surface of the road in order of time in a management unit; and

FIG. 31 is a diagram illustrating another example of a screen displaying information on a state of a surface of a road or information on a state under the surface of the road in order of time in a management unit.

### DESCRIPTION OF EMBODIMENTS

For example, in the method described in Japanese Laid-open Patent Publication No. 2015-176540, in order to evaluate the state of a road more accurately, it is necessary to obtain and consider not only information on flatness of the road but also information on the state of the surface of a road or information on the state under the surface of the road, such as cavities under the surface of the road, adjuncts installed in the road such as manholes and manhole covers, infrastructure facilities necessary for daily lives such as sewage pipes installed under the surface of the road, road signs such as guide signs and regulatory signs, driving information of vehicles such as traffic volume, and repair history of the road.

Moreover, depending on organizations such as the country, local governments, and companies, information on the state of the surface of the road is obtained at different timings, in different regions, and by different methods and is kept in different places, and is also from different management units each being a unit by which the road state is managed. In order to judge the timing of road repair work, it is necessary to obtain written documents and electronic documents describing information on the state of the surface of the road or information on the state under the surface of the road and compare the obtained information with one another for consideration, but this takes a lot of effort and involves difficulties in confirming such information in order of time, which may result in low accuracy in judgment in some cases. Also, in this respect, only experts on road repair work can easily judge the timing of road repair work.

In one aspect, the present disclosure has an object to provide a non-transitory computer-readable recording medium having stored therein a road state management program, a road state management apparatus, and a road state management method that are capable of managing a plurality of pieces of information on a state of a surface of a road or information on a state under a surface of the road in order of time.

It is possible to manage a plurality of pieces of information on a state of a surface of a road or information on a state under a surface of the road in order of time.

An embodiment of the present disclosure will be described below. However, the present disclosure should not be construed as being limited to this embodiment.

Control being performed by each part of a control part of the “road state management apparatus” disclosed herein (hereinafter may also be referred to as “road management platform”, “road condition management server”, etc.) has the same meaning as the “road state management method” disclosed herein being carried out. Therefore, details of the “road state management method” disclosed herein will also be specified through description of the “road state management apparatus” disclosed herein. Further, the road state management program is realized as the “road state management apparatus” disclosed herein with the use of, for example, computers as hardware resources. Therefore, details of the “non-transitory computer-readable recording medium having stored therein a road state management program” disclosed herein will also be specified through description of the “road state management apparatus” disclosed herein.

Examples of the information on the state of the surface of the road or the information on the state under the surface of the road in the road state management program include information on flatness of the road, information on a crack of the road, information on a cavity under the surface of the road, information on an adjunct installed in the road, information on an infrastructure facility under the surface of the road (hereinafter may also be referred to as “infra facility information”), information on a road sign of the road, information on vehicles passing the road, and information on repair history of the road. However, the information on the state of the surface of the road or the information on the state under the surface of the road are not limited thereto, and may be, for example, a rut depth of the road.

The road state management program is stored in a recording medium. This enables the road state management program to be installed in, for example, a computer. The recording medium in which the road state management program is recorded is a non-transitory recording medium. The non-transitory recording medium is not particularly limited and may be appropriately selected depending on the intended purpose. Examples of the non-transitory recording medium include a CD-ROM (Compact Disc-Read Only Memory) and a DVD-ROM (Digital Versatile Disc-Read Only Memory).

(Road State Management Apparatus)

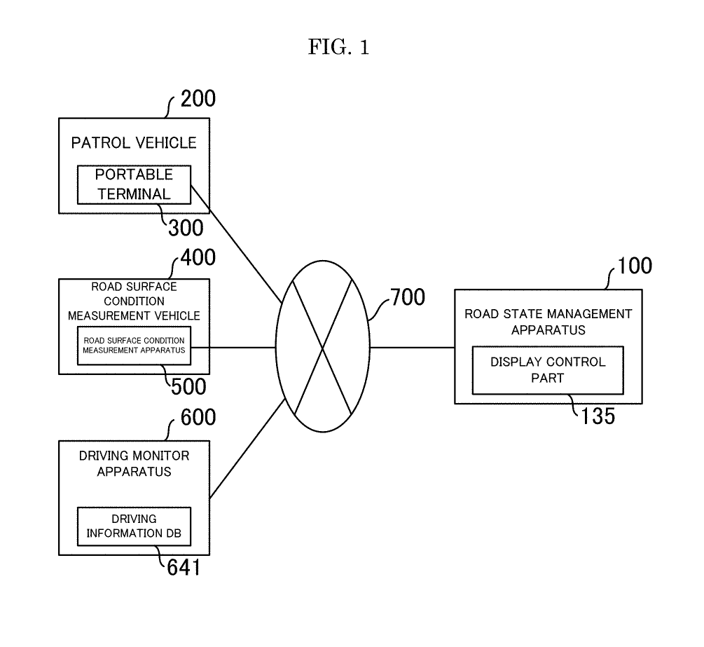

FIG. 1 is a diagram illustrating a configuration of a system including a road state management apparatus 100 according to an embodiment of the present disclosure. The road state management apparatus 100 includes a built-in road state management program. When the road state management apparatus 100 is worked, the road state management method is performed.

The road state management apparatus 100 is for judging the timing of repair work of a road easily and accurately. The road state management apparatus 100 is an apparatus capable of managing a plurality of pieces of information on a state of a surface of a road or information on a state under the surface of the road in order of time, even if the information is collected by different organizations, at different timings, in different regions, by different methods and is kept in different places, and is also from different management units each being a unit by which the road state is managed.

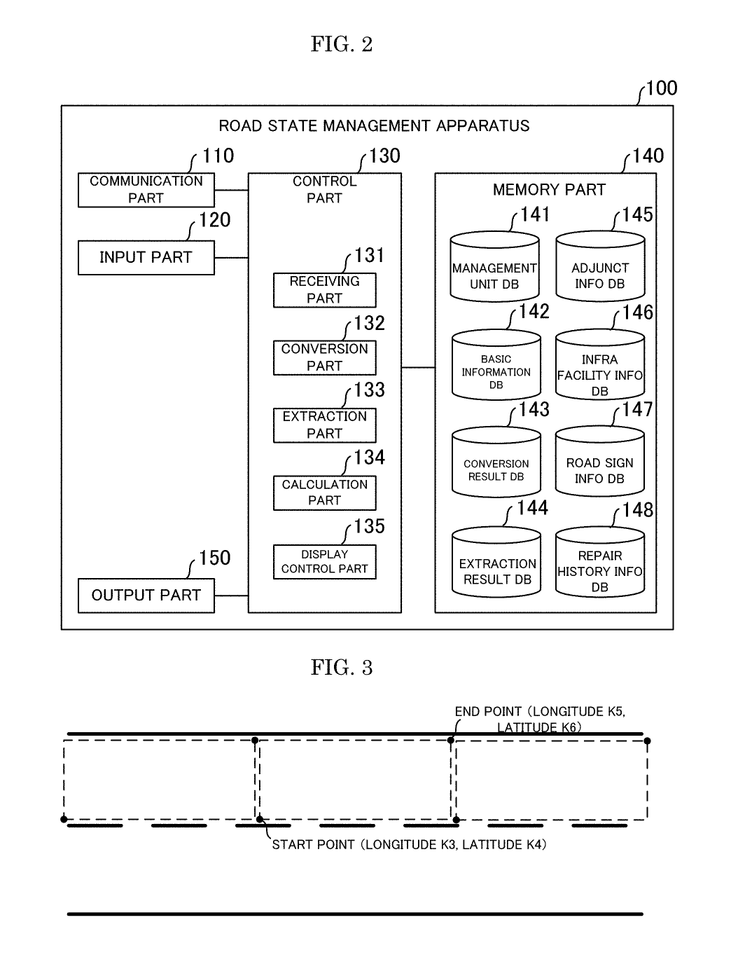

The road state management apparatus 100 constructs a road management platform in order of time based on information on management units each being a unit by which the road state is managed (hereinafter the information on management units is referred to as “management unit information”). Information on a state of a surface of a road and information on a state under the surface of the road; i.e., road state information such as flatness information of the road, crack information of the road, cavity information on a cavity under the surface of the road, adjunct information on an adjunct installed in the road, infra facility information on an infra facility under the surface of the road, road sign information of the road, driving information of vehicles on the road, and repair history information of the road are collected by different organizations, in different units, and at different timings and are kept in different places. Thus, in order to manage the road state information, it is necessary to extract them so as to be in order of time in the management units in the road state management apparatus 100. When such road state information is distributed and extracted by an extraction part 133 in the road state management apparatus 100 illustrated in FIG. 2, it becomes possible to generate an integrated database with which various kinds of road state information are managed in order of time in the management units. Also, when the road management platform is constructed by updating this managing integrated database to the latest information and accumulating various kinds of information, it also becomes possible to display various kinds of information on a road map based on the road management platform.

In the present embodiment, the plurality of pieces of information on the state of the surface of the road or information on the state under the surface of the road in the road state management apparatus 100 are preferably selected from the group including of “flatness information” of the road calculated based on up-and-down acceleration information of driving vehicles, “crack information” of the road sent from a road surface condition measurement apparatus 500, “cavity information” on a cavity under the surface of the road sent from the road surface condition measurement apparatus 500, “driving information” collected by vehicle monitor terminals installed in many vehicles such as trucks and sent from a driving monitor apparatus 600, “adjunct information” on an adjunct installed in the road such as a manhole and a manhole cover and input from the road state management apparatus 100, “infra facility information” on an infra facility such as a sewage pipe installed under the surface of the road, “road sign information” on a sign installed in the road, and “repair history information” of the road. The road state management apparatus 100 distributes the information on the state of the surface of the road or the information on the state under the surface of the road to the management units in order of time, to thereby construct the road management platform.

The road state information, such as flatness information of the road, crack information of the road, cavity information on a cavity under the surface of the road, adjunct information on an adjunct installed in the road, infra facility information on an infra facility under the surface of the road, road sign information of the road, driving information of vehicles on the road, and repair history information of the road, may be sent to the road state management apparatus 100 via a network 700 from, for example, a portable terminal 300 as illustrated in FIG. 1, or may be input from an input part such as a keyboard in the road state management apparatus 100. In the present embodiment, the flatness information is sent from the portable terminal 300 mounted on a patrol vehicle 200, the “crack information” and the “cavity information” are sent from the road surface condition measurement apparatus 500 mounted on a road surface condition measurement vehicle 400, the “driving information” is sent from the driving monitor apparatus 600, and the “adjunct information”, the “infra facility information”, the “road sign information”, and the “repair history information” are input by, for example, a road manager.

The present embodiment is described as an example using eight kinds of road state information; i.e., information on flatness of the road, information on a crack of the road, information on a cavity under the surface of the road, information on an adjunct installed in the road, information on an infra facility under the surface of the road, information on a road sign of the road, information on vehicles passing the road, and information on repair history of the road. This is non-limiting.

As used herein, the management unit refers to a unit by which the road state is managed. As illustrated in FIG. 3, the management unit is represented as a rectangle on a road on a road map, and is defined by setting position information of latitudes and longitudes of two points on the rectangle, namely opposite vertices (start point and end point). This enables a road state to be displayed in a manner to match a road of a road map in the management unit. As a result, it becomes possible to know the road state at a glance.

The range of the rectangle is not particularly limited and may be appropriately selected depending on the intended purpose. For example, when the unit by which an order for work is placed is 100 meters, the length of the longer side of the rectangular ranges may be set to 100 meters uniformly, or may be set based on the distance mark (kilometer post). It is preferable to set the management units in each lane of the road. When there are opposite lanes on the road, the management units are preferably set in each of the opposite lanes.

Next, the road state management apparatus 100 will be described. The road state management apparatus 100 is configured to process the information on the state of the surface of the road or the information of the state under the surface of the road.

FIG. 2 is a diagram illustrating an example of a function configuration of the road state management apparatus 100. The road state management apparatus 100 includes a communication part 110, an input part 120, a control part 130, a memory part 140, and an output part 150.

Next, the control part 130 will be described. The control part 130 is configured to process various kinds of input information on the state of the surface of the road or various kinds of received information on the state of the surface of the road.

<<Control Part>>

The control part 130 includes an obtaining part 131, a conversion part 132, the extraction part 133, a calculation part 134, and a display control part 135.

Next, among the parts of the control part 130, the obtaining part 131 and the extraction part 133 will be described. The obtaining part 131 is configured to obtain at least one information selected from the group including of information on the state of the surface of the road and information on the state under the surface of the road. The extraction part 133 is configured to distribute the received information to one or more management units of the road, and extract the information distributed so as to be in order of time.

The extraction part 133 is configured to distribute the road state information, which is obtained by the obtaining part 131, to one or more management units of the road, and extract the road state information distributed so as to be in order of time. In many cases, the road state information, such as flatness information of the road and crack information of the road, are collected from units different from the management units. In such cases, the obtaining part 131 obtains road state information that is in association with position information different from position information of the management units, and the extraction part 133 distributes the road state information to the management units, and extracts the road state information distributed so as to be in order of time.

Also, the obtaining part 131 performs a process of receiving a designation of the road, making a demand to send or input the road state information of a plurality of road sections obtained by dividing the designated road by units as according to the management units of the road, associating the sent or input road state information with the road sections corresponding to the plurality of road sections, and storing the associated road state information in a memory part. In this case, the management units for which the information is sent or input may be set in advance or may be set each time. The demand to send or input the information may be a demand on a predetermined screen or may be a demand for spreadsheet data, for example. A format usable may be appropriately selected depending on the intended purpose.

In the following, description will be given to a case where the road state information, such as the flatness information and the crack information, is collected from units different from the management units, but, based on position information associated with the road state information, the extraction part 133 performs a process of distributing the road state information collected to the management units and extracting the road state information distributed so as to be in order of time; i.e., the extraction part 133 performs a conversion process of converting the received road state information to information corresponding to the same management units as the management units of the road. In this case, the conversion part 132 matches various kinds of road state information in terms of position information through conversion to position information of latitudes and longitudes, and the extraction part 133 distributes these kinds of information to the management units, each defined by “start point and end point” based on the latitudes and the longitudes, and extracts the information in order of time.

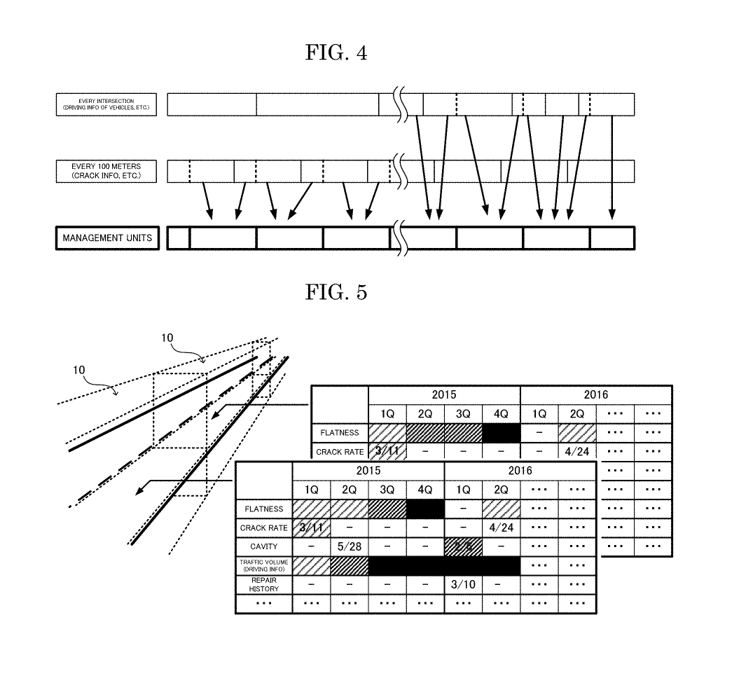

FIG. 4 is a diagram illustrating an example in which the extraction part distributes various kinds of information to the management units. The bottom part in FIG. 4 is the management units in the road state management apparatus 100 according to the present embodiment. The middle part in FIG. 4 is, for example, crack information of the road collected from road units each having a length of 100 meters and different from the management units. The upper part in FIG. 4 is, for example, vehicle driving information from units each being, for example, a range from an intersection to another intersection. As is clear from FIG. 4, for example, the crack information of the road in the middle part and the vehicle driving information in the upper part are present as information in units different from the management units in the road state management apparatus 100 according to the present embodiment. Thus, the conversion part 132 illustrated in FIG. 2 converts their position information to position information of latitudes and longitudes, and then the extraction part 133 distributes the information to the management units based on the position information of latitudes and longitudes. That is, the extraction part 133 can extract the road state information included in the range of the latitudes and the longitudes in one of the management units of the road, and associate the road state information with the one of the management units of the road and extract the road state information in order of time.

In this way, the road state management apparatus 100 can manage a plurality of pieces of information on a state of a surface of a road or information on a state under the surface of the road in order of time in the management units by distributing the information to the management units and extracting the information so as to be in order of time, even if the information is collected by different organizations, at different timings, in different regions, and by different methods and is kept in different places, and is also from different management units each being a unit by which the road state is managed.

For example, as illustrated in FIG. 5, the road state management apparatus 100 displays various kinds of information in order of time quarterly in a year, with more deteriorated road states being displayed at higher densities. This can make it easy to know changes of the road over time. Regarding the information expressed in numerical values, its display density may be determined based on, for example, the maximum value, the average value, and the minimum value that are calculated quarterly. In FIG. 5, the road state management apparatus 100 displays various kinds of information in order of time quarterly in a year. This is non-limiting. The road state management apparatus 100 may display various kinds of information in order of time in appropriately divided periods, such as monthly and weekly.

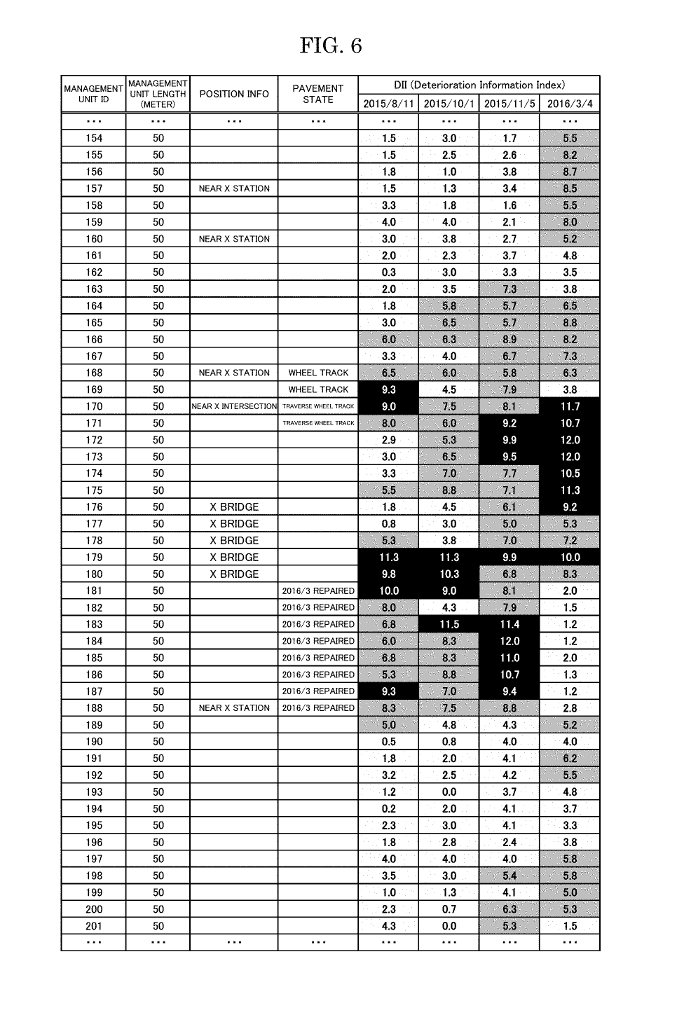

FIG. 6 is a diagram illustrating an example of a table displaying calculation results of DII described below in order of time, as the flatness information of the road. In FIG. 6, similar to FIG. 5, the road state management apparatus 100 displays more deteriorated road flatness at higher densities.

As illustrated in FIG. 6, it can be confirmed that near the management unit ID “173”, the values of DII become higher as time passes and also the areas having high values of DII become wider. In this way, the user can clearly know parts of the road that need repairing. In the range from the management unit ID “181” to the management unit ID “188”, the user can clearly know that flatness is improved after repairing.

As described above, the road state information distributed to the management units and extracted in order of time by the extraction part 133 include flatness information of the road, crack information of the road, cavity information on a cavity under the surface of the road, adjunct information on an adjunct installed in the road, infra facility information on an infra facility under the surface of the road, road sign information of the road, driving information of vehicles on the road, and repair history information of the road. Next, how these kinds of information are received will be described with reference to FIG. 1.

The flatness information is collected by, for example, the portable terminal 300 mounted on the patrol vehicle 200, the crack information and the cavity information are collected by, for example, the road surface condition measurement apparatus 500 mounted on the road surface condition measurement vehicle 400, and the driving information is collected by, for example, the driving monitor apparatus 600. Next, these will also be described.

<Patrol Vehicle>

The patrol vehicle 200 is a vehicle configured to patrol for a road state, and regularly drives on various roads including roads to be patrolled for. The portable terminal 300 mounted on the patrol vehicle 200 measures acceleration along three axes (up-and-down, left-and-right, and front-and-rear) in order to detect the vibration of the patrol vehicle 200 due to deteriorations of the road surface, such as depressions, wheel tracks, and cracks of the road.

The portable terminal 300 is configured to obtain position information of latitudes and longitudes in synchronization with the measurement of acceleration, and associate the position information with the measurement values of acceleration and send them to the road state management apparatus 100.

In the present embodiment, therefore, the measurement values of acceleration obtained from the portable terminal 300 mounted on the patrol vehicle 200 are obtained in association with the position information of latitudes and longitudes.

Examples of the portable terminal 300 include smart devices such as a smart phone and a tablet each having an acceleration sensor unit and a GPS (Global Positioning System) unit.

In the present embodiment, the portable terminal 300 mounted on the patrol vehicle 200 obtains the measurement values of acceleration and the position information of latitudes and longitudes. This is non-limiting. Any device may be used so long as it can obtain measurement values of acceleration and position information of latitudes and longitudes when driving on a road.

<Road Surface Condition Measurement Vehicle>

The road surface condition measurement vehicle 400 is a vehicle configured to measure a road state such as a crack of a road and a cavity under a road surface, and drives on an inspection target road at a frequency of once in several years.

The road surface condition measurement apparatus 500 mounted on the road surface condition measurement vehicle 400 is configured to obtain crack information by dividing a road surface image at every 100 meters, which is captured with, for example, a digital video camera, followed by image processing. The road surface condition measurement apparatus 500 is also configured to obtain cavity information on a cavity under the surface of the road by probing under the surface of the road and dividing the obtained probe image at every 100 meters, followed by image processing. The road surface condition measurement apparatus 500 obtains position information of the latitudes and the longitudes at the start point and the end point on the road divided at every 100 meters, and sends the obtained position information to the road state management apparatus 100 in association with the crack information of the road and the cavity information under the surface of the road.

In the present embodiment, therefore, the crack information and the cavity information, which are obtained from the road surface condition measurement vehicle 400, are managed every 100 meters.

In the present embodiment, the road surface condition measurement vehicle 400 obtains the crack information of the road and the cavity information under the surface of the road. This is non-limiting. The cavity information may be separately obtained by a vehicle having a microwave probe mounted thereon. In the present embodiment, the crack information and the cavity information are managed every 100 meters. This is non-limiting. The crack information and the cavity information may be managed by other different distances or indices.

<Driving Monitor Apparatus>

The driving monitor apparatus 600 is an apparatus configured to daily collect driving information of many vehicles such as trucks each having the vehicle monitor terminal mounted thereon, and monitor a driving state of each of the vehicles. The driving monitor apparatus 600 receives probe information sent from vehicles each having a digital tachograph mounted thereon every range from an intersection to another intersection. The probe information includes information such as speed and acceleration of the vehicles. Based on the probe information received from the vehicle monitor terminals, the driving monitor apparatus 600 generates driving information such as the average speed and the number of sudden braking, and stores the driving information in a driving information database 641 every range from an intersection to another intersection. Hereinafter, the database may also be referred to as “DB”.

In the present embodiment, therefore, the driving information DB 641 in the driving monitor apparatus 600 manages the driving information every range from an intersection to another intersection.

The information representing the range from an intersection to another intersection may also be referred to as “link information”.

Next, details of a road state management system of the present embodiment will be described.

<<Hardware Configuration of Portable Terminal>>

FIG. 7 is a diagram illustrating an example of a hardware configuration of the portable terminal 300. As illustrated in FIG. 7, the portable terminal 300 includes a control part 310, an acceleration sensor unit 320, a GPS unit 330, a memory part 340, and a communication part 350.

The acceleration sensor unit 320 is configured to measure acceleration based on an instruction from the control part 310.

The acceleration sensor unit 320 is not particularly limited and may be appropriately selected depending on the intended purpose so long as it can measure up-and-down acceleration. The acceleration sensor unit 320 is preferably one capable of measuring acceleration along three axes. When the acceleration sensor unit 320 is capable of measuring acceleration along three axes, it is possible from measurement values of front-and-rear acceleration and left-and-right acceleration to calculate variation relative to the measurement value of up-and-down acceleration due to speed change and curves. When the measurement value of up-and-down acceleration is corrected using the variation, the corrected value can become closer to the measurement value of up-and-down acceleration that only reflects the vibration due to deteriorations of the road surface.

The GPS unit 330 is configured to obtain position information of the latitude and the longitude of the portable terminal 300 based on an instruction from the control part 310.

The memory part 340 is configured to store the acceleration information, obtained by the acceleration sensor unit 320 and the GPS unit 330, based on an instruction from the control part 310.

The communication part 350 is configured to send the acceleration information stored in the memory part 340 to the road state management apparatus 100 based on an instruction from the control part 310.

The control part 310 is configured to execute various programs stored in the memory part 340 to control the portable terminal 300 on the whole. Examples of the control part 310 include a CPU (Central Processing Unit).

<<Function Configuration of Portable Terminal>>

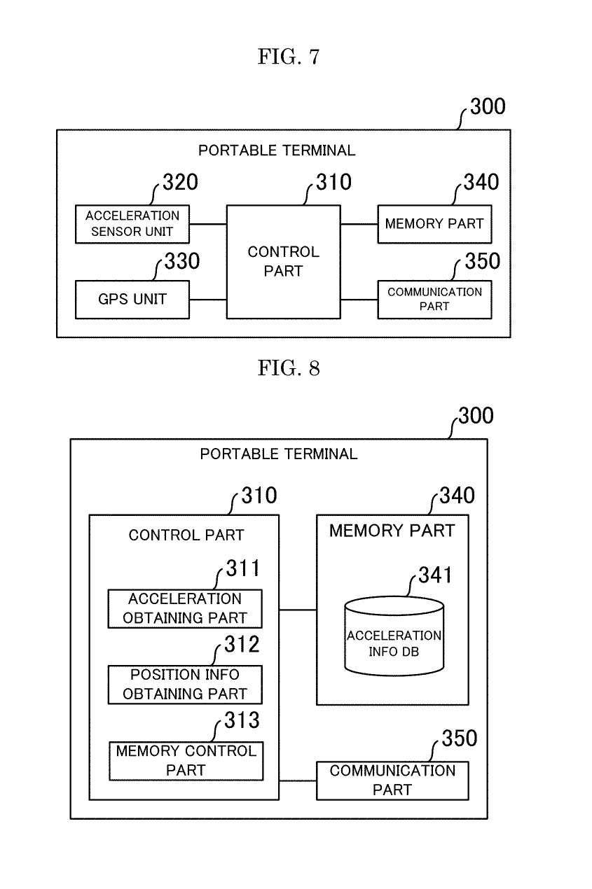

FIG. 8 is a diagram illustrating an example of a function configuration of the portable terminal 300. As illustrated in FIG. 8, the portable terminal 300 includes the control part 310, the memory part 340, and the communication part 350.

The control part 310 includes an acceleration obtaining part 311, a position information obtaining part 312, and a memory control part 313.

The acceleration obtaining part 311 and the position information obtaining part 312 are configured to allow the acceleration sensor unit 320 to measure acceleration along three axes while synchronizing at predetermined cycles, and allow the GPS unit 330 to obtain position information of latitudes and longitudes.

The memory control part 313 is configured to store acceleration information in an acceleration information DB 341 of the memory part 340, the acceleration information associating the measurement values of acceleration along three axes, the position information of the latitude and the longitude obtained in synchronization with the measurement of acceleration, and the date when they are obtained.

The communication part 350 is configured to send the acceleration information stored in the acceleration information DB 341 to the road state management apparatus 100 based on an instruction from the control part 310.

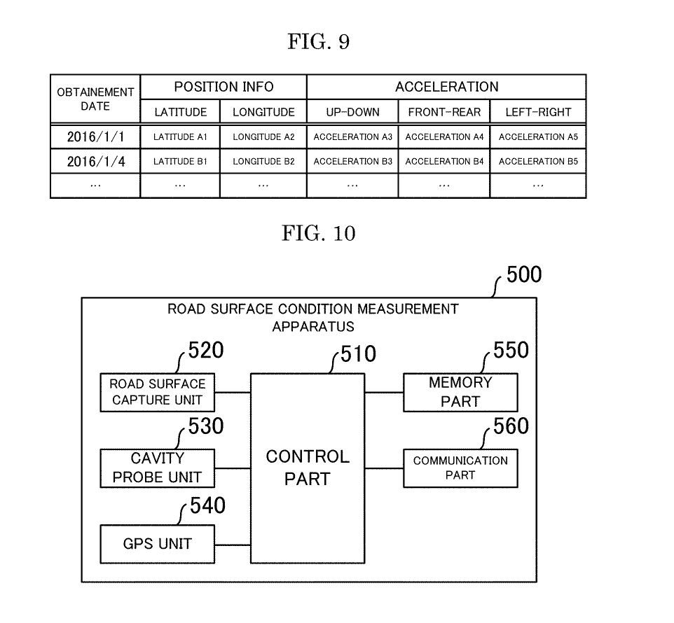

FIG. 9 is a diagram illustrating an example of a table of acceleration information stored in the acceleration information DB. As illustrated in FIG. 9, the acceleration information stored in the acceleration information DB 341 includes items of “obtainment date, position information of a latitude, position information of a longitude, up-and-down acceleration, front-and-rear acceleration, and left-and-right acceleration”.

The “obtainment date” is a date when the patrol vehicle 200 having the portable terminal 300 mounted thereon patrols, and the acceleration sensor unit 320 and a GPS unit 540 obtain the acceleration information.

The “position information of a latitude” and “position information of a longitude” are position information of a latitude and a longitude obtained by the GPS unit 330.

The “up-and-down acceleration” is a measurement value of acceleration measured by the acceleration sensor unit 320 in the vertical direction.

The “front-and-rear acceleration” is a measurement value of acceleration measured by the acceleration sensor unit 320 in the driving direction of the patrol vehicle 200.

The “left-and-right acceleration” is a measurement value of acceleration measured by the acceleration sensor unit 320 in the direction perpendicular to the driving direction of the patrol vehicle 200.

<<Hardware Configuration of Road Surface Condition Measurement Apparatus>>

FIG. 10 is a diagram illustrating an example of a hardware configuration of the road surface condition measurement apparatus 500. As illustrated in FIG. 10, the road surface condition measurement apparatus 500 includes a control part 510, a road surface capture unit 520, a cavity probe unit 530, the GPS unit 540, a memory part 550, and a communication part 560.

The control part 510, the GPS unit 540, the memory part 550, and the communication part 560 are similar to the control part 310, the GPS unit 330, the memory part 340, and the communication part 350 of the portable terminal 300 illustrated in FIG. 7. Thus, these will not be described below.

The road surface capture unit 520 is configured to capture a road surface image using, for example, a digital video camera based on an instruction from the control part 510.

The cavity probe unit 530 is configured to capture a probe image of the state under the surface of the road using, for example, microwaves based on an instruction from the control part 510.

<<Function Configuration of Road Surface Condition Measurement Apparatus>>

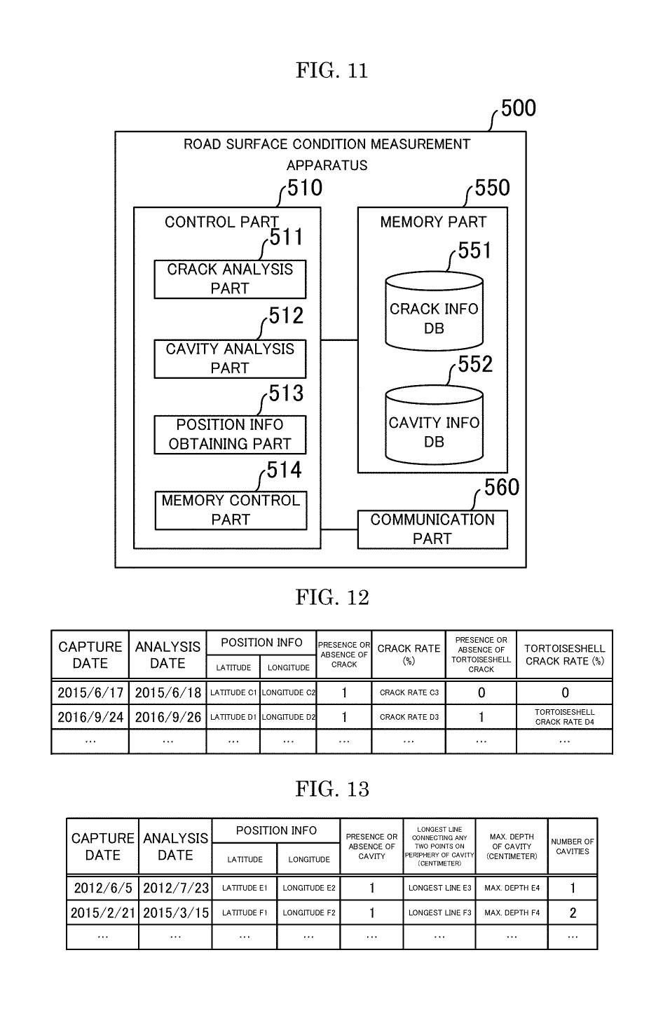

FIG. 11 is a diagram illustrating an example of a function configuration of the road surface condition measurement apparatus 500. As illustrated in FIG. 11, the road surface condition measurement apparatus 500 includes the control part 510, the memory part 550, and the communication part 560.

The control part 510 includes a crack analysis part 511, a cavity analysis part 512, a position information obtaining part 513, and a memory control part 514.

The crack analysis part 511 is configured to perform image analysis of the road surface image captured by the road surface capture unit 520 to obtain information on presence or absence of a crack, a crack rate, presence or absence of a tortoiseshell crack, and a tortoiseshell crack rate.

The cavity analysis part 512 is configured to perform image analysis of a probe image captured by the cavity probe unit 530 to obtain information on presence or absence of a cavity, the longest line connecting two points on the periphery of the cavity, the maximum depth of the cavity, and the number of cavities.

The position information obtaining part 513 is configured to obtain, using the GPS unit 540, position information of the latitudes and the longitudes at the start point and the end point in each of the road sections divided at every 100 meters.

The memory control part 514 is configured to store crack information in a crack information DB 551 of the memory part 550, the crack information associating the information obtained as a result of the image analysis in the crack analysis part 511 with the position information of the latitudes and the longitudes at the start point and the end point in each of the road sections divided at every 100 meters and with the capture date and the analysis date.

Similar to the crack information of the road, the memory control part 514 is configured to store cavity information on a cavity under the surface of the road in a cavity information DB 552 of the memory part 550, the cavity information associating the information obtained as a result of the image analysis in the cavity analysis part 512 with the position information of the latitudes and the longitudes at the start point and the end point in each of the road sections divided at every 100 meters and with the capture date and the analysis date.

The communication part 560 is configured to send the crack information stored in the crack information DB 551 to the road state management apparatus 100 based on an instruction from the control part 510. The communication part 560 is configured to send the cavity information stored in the cavity information DB 552 to the road state management apparatus 100 based on an instruction from the control part 510.

FIG. 12 is a diagram illustrating an example of the crack information stored in the crack information DB. As illustrated in FIG. 12, the crack information stored in the crack information DB includes items of “capture date, analysis date, position information of a latitude, position information of a longitude, presence or absence of a crack, a crack rate, presence or absence of a tortoiseshell crack, and a tortoiseshell crack rate”.

The “capture date” is a date when the road surface image is captured by the road surface capture unit 520.

The “analysis date” is a date when the road surface image is analyzed through image processing in the crack analysis part 511.

The “position information of a latitude” and the “position information of a longitude” are position information of the latitudes and the longitudes at the start point and the end point in each of the road sections divided at every 100 meters.

The “presence or absence of a crack” is whether a crack is present or absent in the road surface as a result of the image processing of the road surface image in the crack analysis part 511. When a crack is present, “1” is input, whereas when a crack is absent, “0” is input.

The “crack rate” is a value obtained from the result of the image processing of the road surface image in the crack analysis part 511 based on the criteria of the traditionally used MCI (Maintenance Control Index: maintenance control index for pavements).

The “presence or absence of a tortoiseshell crack” is whether a tortoiseshell crack is present or absent in the road surface as a result of the image processing of the road surface image in the crack analysis part 511. When a tortoiseshell crack is present, “1” is input, whereas when a tortoiseshell crack is absent, “0” is input. The tortoiseshell crack means a crack having a tortoiseshell closed pattern as a result of development of linear cracks occurring at an initial stage and joining of the linear cracks with one another.

The “tortoiseshell crack rate” is a value obtained from the result of the image processing of the road surface image in the crack analysis part 511 based on the criteria of the MCI limited to the tortoiseshell crack.

FIG. 13 is a diagram illustrating an example of the cavity information stored in the cavity information DB. As illustrated in FIG. 13, the cavity information stored in the cavity information DB 552 includes items of “capture date, analysis date, position information of a latitude, position information of a longitude, presence or absence of a cavity, the longest line connecting two points on the periphery of the cavity, the maximum depth of the cavity, and the number of cavities”.

The “capture date” is a date when the probe image is captured by the cavity probe unit 530.

The “analysis date” is a date when the probe image is analyzed through image processing in the cavity analysis part 512.

The “position information of a latitude” and the “position information of a longitude” are position information of the latitudes and the longitudes obtained by the GPS unit 540 at the start point and the end point in each of the road sections divided at every 100 meters.

The “presence or absence of a cavity” is whether a cavity is present or absent under the surface of the road as a result of the image processing of the probe image in the cavity analysis part 512. When a cavity is present, “1” is input, whereas when a cavity is absent, “0” is input.

The “longest line connecting two points on the periphery of the cavity”, the “maximum depth of a cavity”, and the “number of cavities” are values obtained from the result of the image processing of the probe image in the cavity analysis part 512.

<<Hardware Configuration of Driving Monitor Apparatus>>

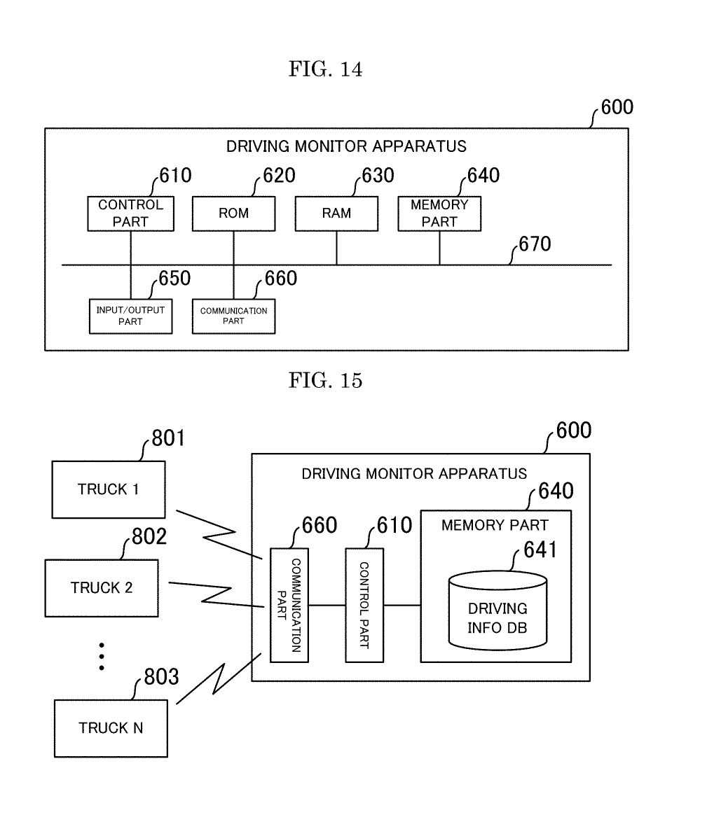

FIG. 14 is a diagram illustrating an example of a hardware configuration of the driving monitor apparatus 600. As illustrated in FIG. 14, the driving monitor apparatus 600 includes a control part 610, a ROM (Read Only Memory) 620, a RAM (Random Access Memory) 630, a memory part 640, an input/output part 650, and a communication part 660. The parts of the driving monitor apparatus 600 are communicably connected to one another via a bus 670.

The ROM 620 is configured to store, for example, various programs and data necessary for the control part 610 to execute various programs stored in the memory part 640. Specifically, the ROM 620 stores, for example, boot programs such as a BIOS (Basic Input/Output System) and an EFI (Extensible Firmware Interface).

The RAM 630 is a main memory, and is configured to function as a work area to be developed when the various programs stored in the memory part 640 are executed by the control part 610. Examples of the RAM 630 include a DRAM (Dynamic Random Access Memory) and an SRAM (Static Random Access Memory).

The memory part 640 includes the driving information DB 641 and is configured to store, for example, various programs installed in the driving monitor apparatus 600 and data generated by execution of programs based on an instruction from the control part 610.

The input/output part 650 is configured to receive various kinds of instructions to the driving monitor apparatus 600. The input/output part 650 is also configured to display an internal status of the driving monitor apparatus 600.

The communication part 660 is configured to wirelessly receive driving information from the driving monitor terminal mounted on each truck based on an instruction from the control part 610. The communication part 660 is configured to send driving information via the network 700 to the road state management apparatus 100 based on an instruction from the control part 610.

The control part 610 is configured to execute various programs stored in the memory part 640 and control the driving monitor apparatus 600 on the whole.

Examples of the control part 610 include a CPU.

<<Function Configuration of Driving Monitor Apparatus>>

FIG. 15 is a diagram illustrating an example of a function configuration of the driving monitor apparatus 600. As illustrated in FIG. 15, the driving monitor apparatus 600 includes the control part 610, the memory part 640, and the communication part 660.

The communication part 660 is configured to receive driving information from the vehicle monitor terminal mounted on each vehicle. The control part 610 stores the driving information received by the communication part 660 in the driving information DB 641 in the memory part 640.

The driving information includes items of the driving history, the average speed, and the number of sudden braking of each vehicle every range indicated by the link information. The driving information is information associated with the link information serving as the position information.

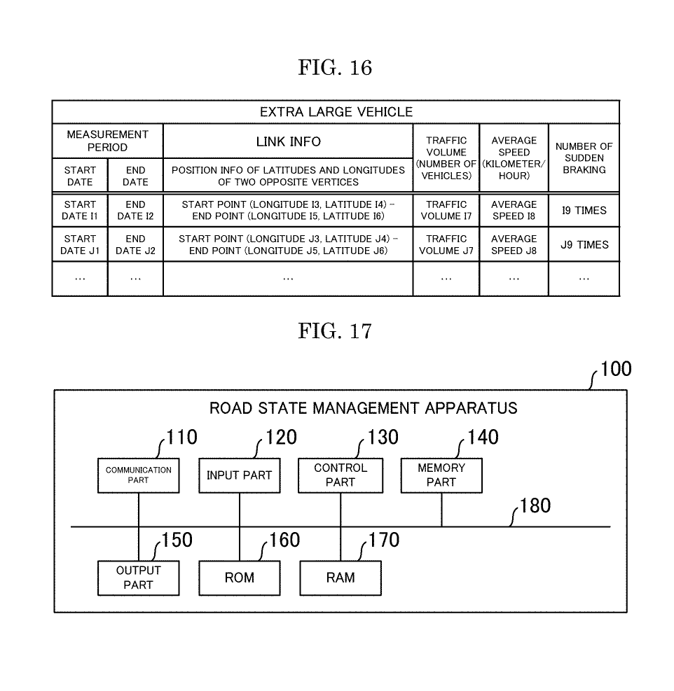

FIG. 16 is a diagram illustrating an example of the driving information stored in the driving information DB 641. As illustrated in FIG. 16, the driving monitor apparatus 600 is configured to obtain, as the driving information, “a measurement period, link information, a traffic volume, an average speed, and the number of sudden braking” that are in association with one another. Preferably, the driving information is individually obtained depending on a vehicle type class ranging from an extra large vehicle to a small vehicle. FIG. 16 is a diagram illustrating driving information of an extra large vehicle as an example.

In the “measurement period”, “start date” is a date when the measurement is started and “end date” is a date when the measurement is ended.

The “link information” is information indicating a range from an intersection to another intersection, and is position information (latitudes and longitudes) of two opposite vertices in a range represented by a rectangle on a road map.

The “traffic volume” is the number of vehicles driving through the range indicated by the link information during the measurement period.

The “average speed” is an average speed of the vehicles driving through the range indicated by the link information during the measurement period.

The “number of sudden braking” is the number of sudden braking taken in the range indicated by the link information during the measurement period.

<Hardware Configuration of Road State Management Apparatus>

FIG. 17 is a diagram illustrating an example of a hardware configuration of the road state management apparatus 100. As illustrated in FIG. 17, the road state management apparatus 100 includes the communication part 110, the input part 120, the control part 130, the memory part 140, the output part 150, a ROM 160, and a RAM 170. The parts of the road state management apparatus 100 are communicably connected to one another via a bus 180.

The communication part 110 is configured to receive various kinds of information from the portable terminal 300, the road surface condition measurement apparatus 500, the driving monitor apparatus 600, and the road state management apparatus 100 illustrated in FIG. 1 based on an instruction from the control part 130.

In the present embodiment, a communication part 450 is configured to receive various kinds of information based on an instruction from the control part 130. Alternatively, the communication part 450 may be configured to output an instruction for sending various kinds of information from each part via the network 700.

The input part 120 is configured to receive various kinds of instructions to the road state management apparatus 100.

The control part 130 is configured to execute various programs stored in the memory part 140 and control the road state management apparatus 100 on the whole. Examples of the control part 130 include a CPU.

The memory part 140 is configured to store, for example, various programs installed in the road state management apparatus 100 and data generated by execution of programs based on an instruction from the control part 130.

The output part 150 is used as, for example, a display in the present embodiment, and is configured to display an internal status of the road state management apparatus 100.

The ROM 160 is configured to store, for example, various programs and data necessary for the control part 130 to execute various programs stored in the memory part 140.

The RAM 170 is a main memory, and is configured to function as a work area to be developed when the various programs stored in the memory part 140 are executed by the control part 130. Examples of the RAM 170 include a DRAM and an SRAM.

<Function Configuration of Road State Management Apparatus>

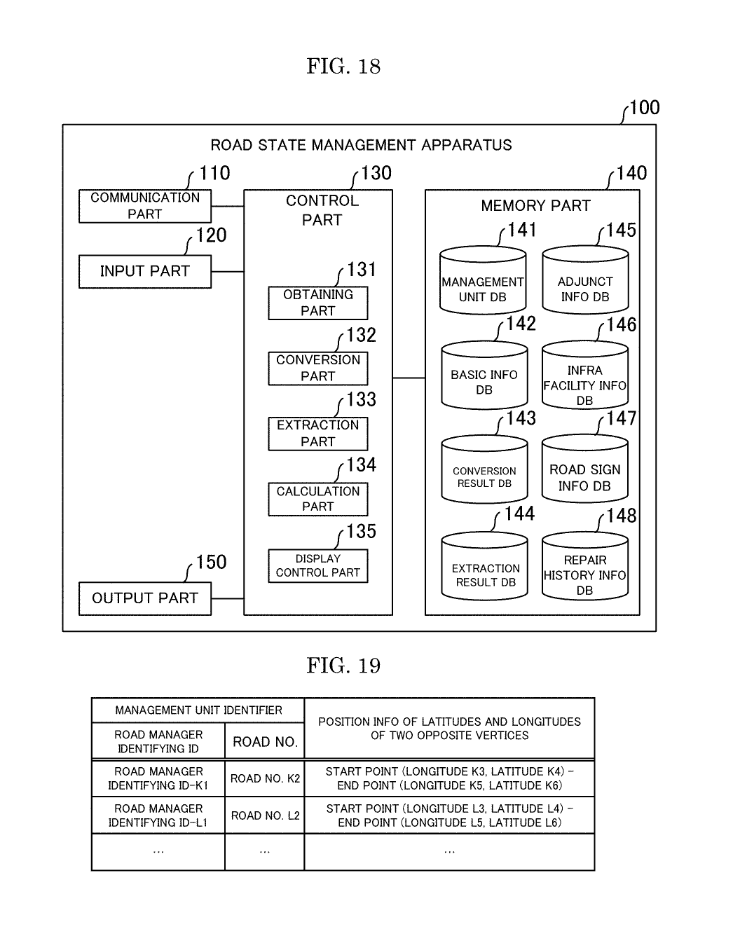

FIG. 18 is a diagram illustrating an example of a function configuration of the road state management apparatus 100. As illustrated in FIG. 18, the road state management apparatus 100 includes the communication part 110, the input part 120, the control part 130, the memory part 140, and the output part 150.

The memory part 140 includes a management unit DB 141, a basic information DB 142, a conversion result DB 143, an extraction result DB 144, an adjunct information DB 145, an infra facility information DB 146, a road sign information DB 147, and a repair history information DB 148. The information to be stored in each DB will be mentioned while describing each part in the road state management apparatus 100.

The input part 120 is, for example, a keyboard in the present embodiment. The input part 120 enables a user to input the management unit information, the adjunct information on an adjunct installed in the road, the infra facility information on an infra facility under the surface of the road, the road sign information of the road, the repair history information of the road, and other various kinds of information.

The output part 150 is, for example, a display in the present embodiment. The output part 150 can output, for a user, the management unit information, the adjunct information on an adjunct installed in the road, the infra facility information on an infra facility under the surface of the road, the road sign information of the road, and the repair history information of the road. The output part 150 can also display other various kinds of information on a map.

FIG. 19 is a diagram illustrating an example of the management unit information stored in the management unit DB. As illustrated in FIG. 19, the management unit DB 141 stores, as the management unit information, “a road manager ID, a road number, and position information of latitudes and longitudes of two opposite vertices” that are in association with one another.

The “road manager ID” is an identifier identifying a road manager. The road manager may be, for example, a national highway office or a road manager of, for example, a prefecture.

The “road number” is an identifier identifying a road uniquely.

The “position information of latitudes and longitudes of two opposite vertices” defines the range of the management unit by setting “start point” and “end point”. As the settings of the position information of latitudes and longitudes of two opposite vertices, the “start point” is position information indicating a start position of the management unit, and is specified by a latitude and a longitude thereof. The “end point” is position information indicating an end position of the management unit, and is specified by a latitude and a longitude thereof.

By setting the management unit information in this way, the management unit on a road identified by “Road Number=K2” of “Road Administrator Identifying ID=K1” in FIG. 19 is a range of the rectangle defined by the start point (Latitude K3, Longitude K4) and the end point (Latitude K5, Longitude K6) as illustrated in FIG. 20.

The settings of the management unit information are preferably performed based on the road map information.

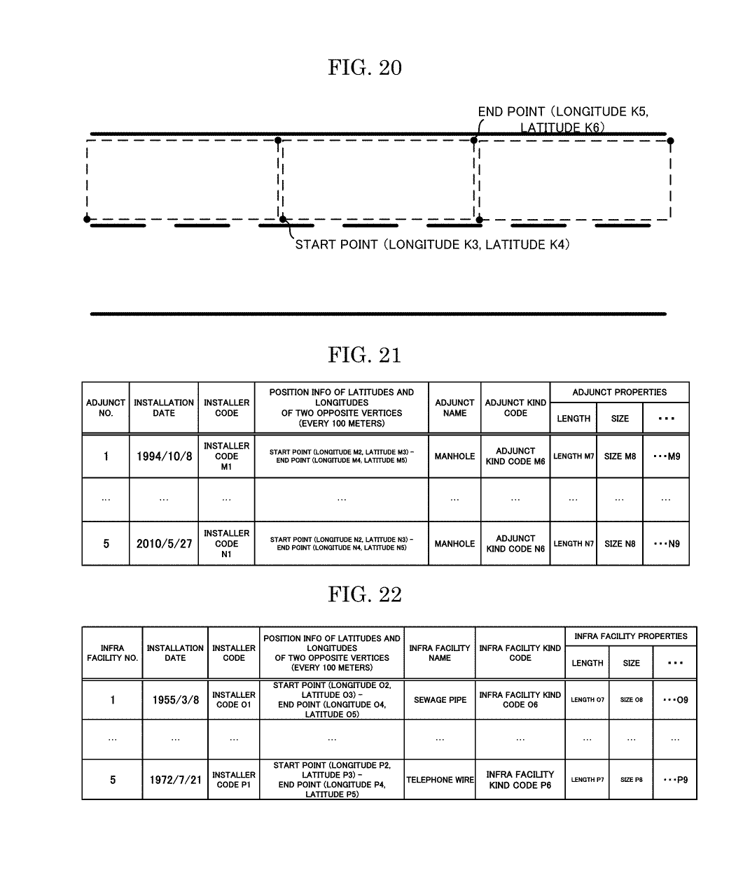

FIG. 21 is a diagram illustrating an example of adjunct information stored in the adjunct information DB. As illustrated in FIG. 21, the adjunct information DB 145 stores, as the adjunct information, “an adjunct number, an installation date, an installer code, an adjunct name, an adjunct kind code, and adjunct properties” that are in association with one another.

The “adjunct number” is a serial number of the adjunct installed in the road for which the management unit is set.

The “installation date” is a date when the adjunct is installed.

The “installer code” is an identifier identifying a person who installs the adjunct.

The “adjunct name” is a name of the adjunct such as a manhole and a manhole cover.

The “adjunct kind code” is an identifier identifying a kind of the adjunct.

The “adjunct properties” are, for example, the length and the size of the adjunct.

FIG. 22 is a diagram illustrating an example of the infra facility information stored in the infra facility information DB. As illustrated in FIG. 22, an infra facility information DB 537 stores, as the infra facility information, “an infra facility number, an installation date, an installer code, an infra facility name, an infra facility kind code, and infra facility properties” that are in association with one another.

The “infra facility number” is a serial number of the infra facility installed in the road for which the management unit is set.

The “installation date” is a date when the infra facility is installed.

The “installer code” is an identifier identifying a person who installs the infra facility.

The “infra facility name” is a name of the infra facility such as a sewage pipe.

The “infra facility kind code” is an identifier identifying a kind of the infra facility.

The “infra facility properties” are, for example, the length and the size of the infra facility.

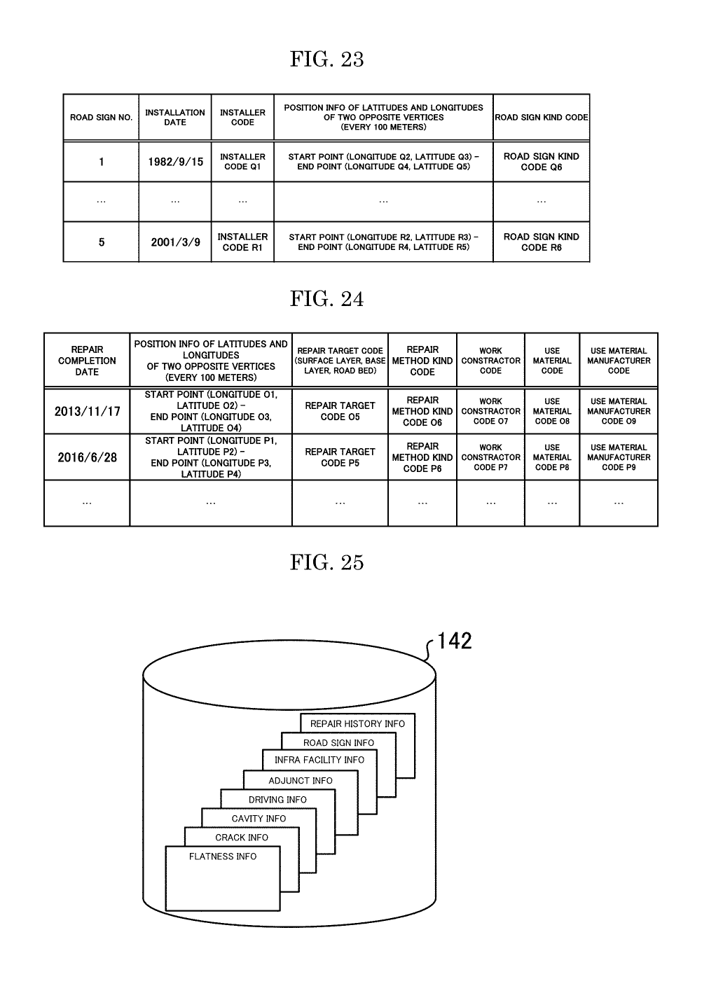

FIG. 23 is a diagram illustrating an example of the road sign information stored in the road sign information DB. As illustrated in FIG. 23, the road sign information DB 537 stores, as the road sign information, “a road sign number, an installation date, an installer code, and a road sign kind code” that are in association with one another.

The “road sign number” is a serial number of the road sign installed in the road for which the management unit is set.

The “installation date” is a date when the road sign is installed.

The “installer code” is an identifier identifying a person who installs the road sign.

The “road sign kind code” is an identifier identifying a kind of the road sign.

FIG. 24 is a diagram illustrating an example of the repair history information stored in the repair history information DB. As illustrated in FIG. 24, the repair history information DB 148 stores, as the repair history information, “a repair completion date, a repair target code, a repair method kind code, a work contractor code, a use material code, and a use material manufacturer code” that are in association with one another.

The “repair completion date” is a date when the repair of the road is completed.

The “repair target code” is an identifier for the repaired layer.

The “repair method kind code” is an identifier for a kind of the method by which the repair is performed.

The “work contractor code” is an identifier for a person who contracts the work.

The “use material code” is an identifier for a material used for the repair.

The “use material manufacturer code” is an identifier for a material manufacturer of the material used for the repair.

Based on an instruction from the control part 130, the communication part 110 is configured to receive the acceleration information, the crack information of the road, the cavity information under the surface of the road, and the driving information from the portable terminal 300, the road surface condition measurement apparatus 500, and the driving monitor apparatus 600.

In order to specify the sender when receiving the information, it is preferable to confirm that the sender is the proper information generator, or that the information has not been falsified, using, for example, a known electronic signature technology. Alternatively, it is preferable to confirm that the sender is the proper information generator, and that the information has not been falsified, using, for example, a known electronic signature technology. It is more preferable to manage the deadline for information exchange, and to reject receiving information after a predetermined time period has passed.

The communication part 110 may receive the information at any time, or, for example, the user may manually collect the information from the portable terminal 300, the road surface condition measurement apparatus 500, and the driving monitor apparatus 600.

<<Control Part>>

The control part 130 includes the obtaining part 131, the conversion part 132, the extraction part 133, the calculation part 134, and the display control part 135. Examples of the control part 130 include a processor such as a CPU. The control part 130 is configured to execute the process of the road state management apparatus 100 on the whole. The processor that executes software is hardware.

—Obtaining Part—

The obtaining part 131 is configured to obtain not only information managed based on the same position information as the position information of the management units but also information managed based on position information defined differently from the position information of the management units, and store the information in the basic information DB 142 as illustrated in FIG. 25.

—Conversion Part—

The conversion part 132 is configured to convert position information different from the position information of the management units to position information of a latitude and a longitude. Specifically, the conversion part 132 converts information associated with position information other than position information of a latitude and a longitude and stored by the obtaining part 131 in the basic information DB 142, to information based on position information of a latitude and a longitude and stores the converted information in the conversion result DB 143. For example, in the case of the driving information stored in the driving information DB 641 in which the position information is the link information, the conversion part 132 converts the link information to position information of a latitude and a longitude and stores the converted information in the conversion result DB 143.

When the information obtained by the obtaining part 131 is information from the management unit, the conversion part 132 stores the information in the basic information DB 142 and then stores the information in the conversion result DB 143 without conversion to position information of a latitude and a longitude.

More specifically, the conversion part 132 converts position information other than position information of a latitude and a longitude to position information of a latitude and a longitude, divides or binds measurement results to be associated with the position information, and converts the measurement results to information associated with the position information of a latitude and a longitude. For example, the conversion part 132 identifies position information of a latitude and a longitude at the center of a section between an intersection and another intersection identified by the link information, and performs conversion to the identified position information of a latitude and a longitude.

When converting information from a distance unit that is long to some extent rather than the link information, for example, when converting crack information of every 100 meters of the road measured by the road surface condition measurement apparatus 500, the conversion part 132 divides the distance unit into sections having any length based on the position information of latitudes and longitudes of the start point and the end point in the management unit information, and stores the crack information based on position information of latitudes and longitudes of the divided sections.

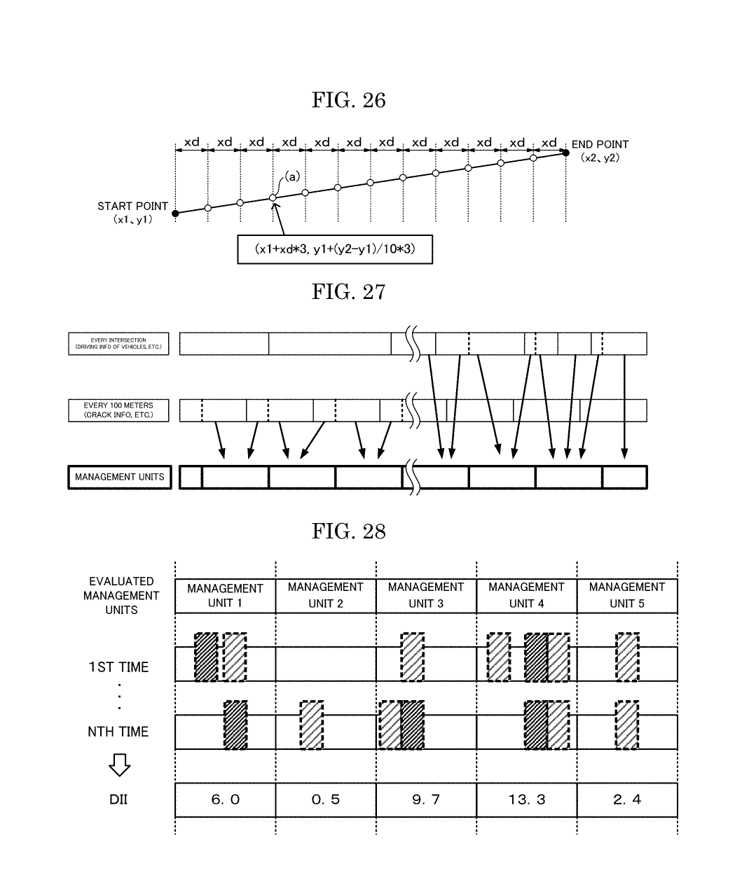

FIG. 26 is a diagram illustrating an example of a method for determining position information of a latitude and a longitude from position information from each of the predetermined distance units. As illustrated in FIG. 26, when the position information is managed by coordinates (latitudes and longitudes) from the start point (x1, y1) to the end point (x2, y2), the conversion part 132 divides the distance on the latitude between the start point and the end point into latitudes “xd”, and also divides measurement results from the start point to the end point by the divided number of the latitude. FIG. 26 is an example in which the distance is divided into “11”. For example, position information (x, y) of (a) in FIG. 26 is determined as (x1+xd×3, y1+(y2−y1)/10×3). When the distance is divided into “11” as the latitudes “xd”, the conversion part 132 also divides measurement results into “11”, and converts the measurement results to information in which the position information of latitudes and longitudes obtained as a result of this dividing is associated with the divided measurement results.

For example, a cumulative number such as the number of sudden braking can be easily divided, but an image, etc. cannot be divided. In this case, images captured at position coordinates are associated with the divided position information (position information of latitudes and longitudes). For example, in FIG. 26, the images captured from the start point to the end point are associated with the divided “11” position information (position information of latitudes and longitudes).

—Extraction Part—

Referring back to FIG. 2, the extraction part 133 is configured to distribute a plurality of pieces of information on the state of the surface of the road, which are associated with position information different from position information of the management units, to the management units and extract the information in order of time. Specifically, the extraction part 133 distributes various kinds of information, position information of which is converted by the conversion part 132 to position information of latitudes and longitudes to match the position information of the management units, to the management units each defined by “start point and end point” of latitudes and longitudes, and stores the information in the extraction result DB 144 in order of time.

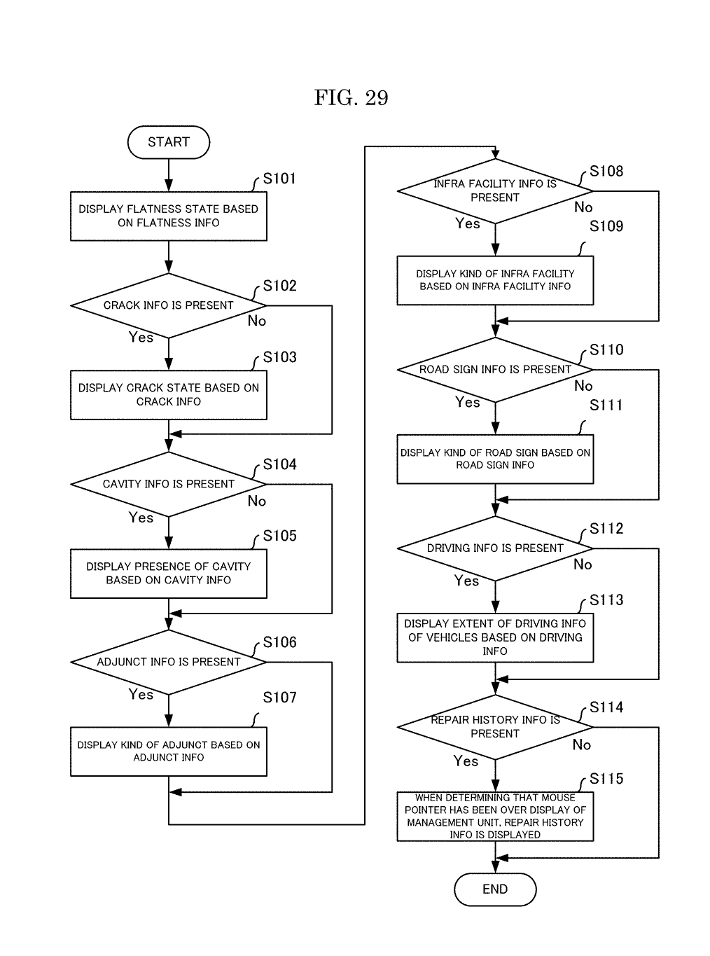

FIG. 27 is a diagram illustrating an example in which the extraction part 133 distributes various kinds of information to the management units and extracts the information in order of time. As illustrated in FIG. 27, regardless of whether the information is information having position information of link ranges each being a range from an intersection to another intersection, or information having position information of every 100 meters, since the position information is converted by the conversion part 132 to position information of latitudes and longitudes, the extraction part 133 can distribute the information to the management units based on the position information of latitudes and longitudes and extract the information in order of time.

In this way, even when receiving a plurality of pieces of information on the state of the surface of the road or information on the state under the surface of the road that are managed based on position information defined differently from the position information of the management units, the road state management apparatus 100 distributes the plurality of pieces of the information on the state of the surface of the road or information on the state under the surface of the road to the management units and extracts the information distributed so as to be in order of time. As a result, the road state management apparatus 100 can manage the plurality of pieces of the information on the state of the surface of the road or information on the state under the surface of the road even if the plurality of pieces of information are associated with mutually different position information.

—Calculation Part—

The calculation part 134 is configured to calculate flatness information of the road based on the acceleration information obtained by the portable terminal 300. The calculation part 134 is configured to store the calculated flatness information of the road in the extraction result DB 144 based on the management units.

The flatness information of the road is not particularly limited and may be appropriately selected depending on the intended purpose so long as it is information indicative of flatness of a road calculated based on the acceleration information daily measured by the portable terminal 300 mounted on the patrol vehicle 200. Examples of the flatness information include an MCI, an IRI (International Roughness Index), and a DII (Deterioration Information Index) (registered trademark, FUJITSU LIMITED). Although how to calculate the flatness information of the road is described taking a method based on the acceleration information as an example, it is also possible to calculate flatness with other calculation methods based on, for example, angular speed information.

In the present embodiment, the calculation part 134 calculates the DII as the flatness information of the road.

—DII—

The DII is calculated based on the notion that at a point where up-and-down acceleration is found to greatly fluctuate as a result of acceleration measurement by acceleration sensors for three axes in the portable terminal 300, the patrol vehicle 200 is assumed to greatly rock and thus the road surface condition is assumed to be deteriorated.

The calculation method of the DII includes the following steps. The first step is to extract a point where there is a great fluctuation in the measurement value of up-and-down acceleration. The next step is to correct the measurement value of up-and-down acceleration for the fluctuation due to speed change and curves with reference to front-and-rear acceleration and left-and-right acceleration at the extracted point, and score the fluctuation in the measurement value of up-and-down acceleration. The final step is to calculate the DII as an average score in each management unit from the scores in the acceleration measurement performed a plurality of times in order to ensure reliability as information because the acceleration is measured in a simple manner.

FIG. 28 is a diagram illustrating an example of the calculation method of the DII. FIG. 28 presents measurement results of the fluctuation in up-and-down acceleration at the 1st time to the Nth time in management unit 1 to management unit 5. Each of the positions corresponding to the square symbols enclosed by dotted lines represents a point where there is a great fluctuation in acceleration. The color density of the symbols represents the fluctuation level of acceleration, and scoring is performed based on the fluctuation level.

The DII is a value obtained by scoring the measurement results at the 1st time to the Nth time in each management unit and calculating an average of the scores. The DII becomes greater in the management unit including more symbols that represent great fluctuation levels of acceleration.

In the present embodiment, the calculation part 134 stores the calculated DII in a management unit distribution result DB 532 based on the management units.

—Display Control Part—

The display control part 135 is configured to perform control for displaying the information on the state of the surface of the road or the information on the state under the surface of the road on a road map based on the management units. The display control part 135 can also display changes over time on a user terminal or a driving management server. The display control part 135 can also send information relating to the management unit to a vehicle driving in the management unit and display the information on a device mounted on the vehicle.

FIG. 29 is a flowchart illustrating an example of a flow in which the display control part 135 performs control for displaying the information on the state of the surface of the road or the information on the state under the surface of the road on a road on a road map based on the management units. Control by the display control part 135 for displaying the information on the state of the surface of the road or the information on the state under the surface of the road will be described in accordance with the flowchart illustrated in FIG. 29.

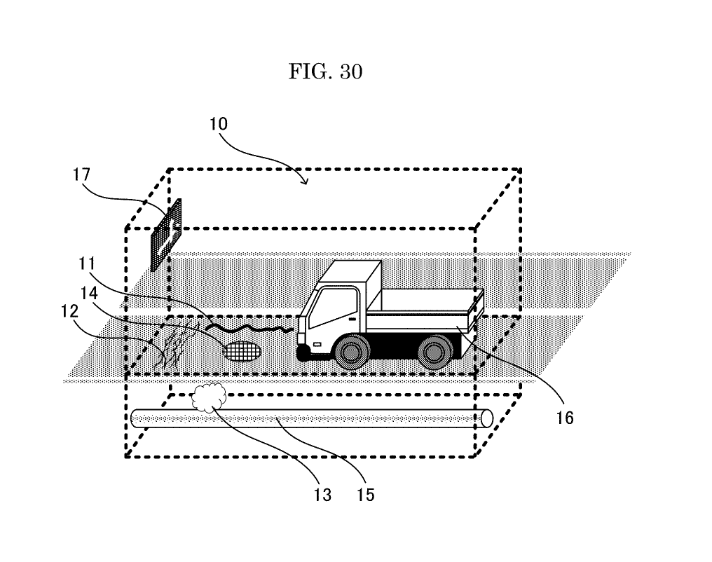

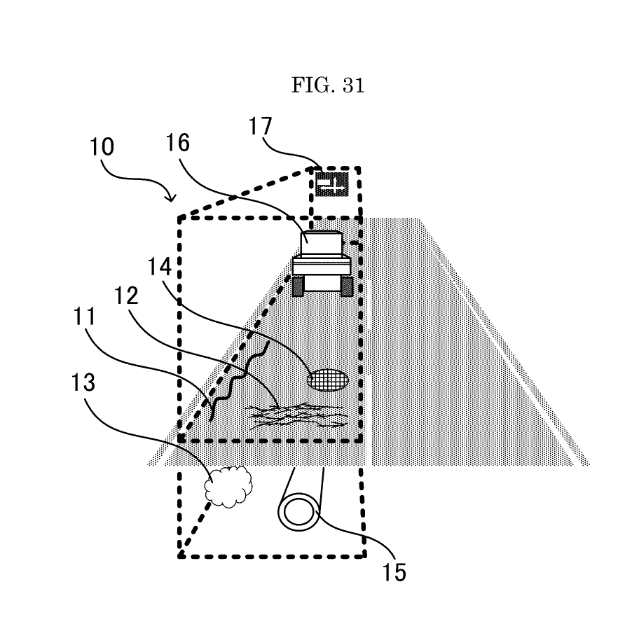

In the step S101, the display control part 135 displays a flatness state based on a value of the DII, which is the flatness information of the road. In the present embodiment, the display control part 135 displays the flatness state with the extent of undulation of a line displayed on the road surface as illustrated in FIG. 30, and moves the process to the step S102. The display control part 135 expresses better flatness with a line that is closer to a straight line, and worse flatness with a more undulating line.

In the step S102, the display control part 135 determines whether crack information of the road is present or absent. When determining that the crack information is present, the display control part 135 moves the process to the step S103. When determining that the crack information is absent, the display control part 135 moves the process to the step S104.

In the step S103, the display control part 135 displays a crack state with a crack figure based on the crack information of the road. In the present embodiment, the display control part 135 displays the crack state at the following three different levels based on the crack information in the management units, and moves the process to the step S104.

(1) No crack: No crack figure is displayed.

(2) Non-tortoiseshell crack (linear crack): Figure of a linear crack is displayed.

(3) Tortoiseshell crack: Figure of a tortoiseshell crack is displayed.

In the step S104, the display control part 135 determines whether cavity information on a cavity under the surface of the road is present or absent. When determining that the cavity information is present, the display control part 135 moves the process to the step S105. When determining that the cavity information is absent, the display control part 135 moves the process to the step S106.

In the step S105, the display control part 135 displays presence of a cavity under the surface of the road based on the cavity information, and moves the process to the step S106.

In the step S106, the display control part 135 determines whether adjunct information on an adjunct installed in the road is present or absent. When determining that the adjunct information is present, the display control part 135 moves the process to the step S107. When determining that the adjunct information is absent, the display control part 135 moves the process to the step S108.

In the step S107, the display control part 135 displays the kind of the adjunct based on the adjunct information, and moves the process to the step S108.

In the step S108, the display control part 135 determines whether infra facility information on an infra facility such as a sewage pipe installed under the surface of the road is present or absent. When determining that the infra facility information is present, the display control part 135 moves the process to the step S109. When determining that the infra facility information is absent, the display control part 135 moves the process to the step S110.

In the step S109, the display control part 135 displays the infra facility based on the infra facility information, and moves the process to the step S110.

In the step S110, the display control part 135 determines whether road sign information of the road is present or absent. When determining that the road sign information is present, the display control part 135 moves the process to the step S111. When determining that the road sign information is absent, the display control part 135 moves the process to the step S112.

In the step S111, the display control part 135 displays the kind of the road sign based on the road sign information, and moves the process to the step S112.

In the step S112, the display control part 135 determines whether driving information of vehicles is present or absent. When determining that the driving information is present, the display control part 135 moves the process to the step S113. When determining that the driving information is absent, the display control part 135 moves the process to the step S114.

In the step S113, the display control part 135 displays the extent of the driving information based on the drive information, and moves the process to the step S114.

In the step S114, the display control part 135 determines whether repair history information of the road is present or absent. When determining that the repair history information is present, the display control part 135 moves the process to the step S115. When determining that the repair history information is absent, the display control part 135 terminates the process.

In the step S115, the display control part 135 associates the repair history information with the management units, and terminates the process. When determining that the mouse pointer has been over the display of one of the management units, the display control part 135 displays the repair history information of the one of the management units.

In this way, by controlling displaying, on a road on a road map, at least one information selected from the group including of flatness information of the road, crack information of the road, cavity information on a cavity under the surface of the road, adjunct information on an adjunct installed in the road, driving information of vehicles on the road, and repair history information of the road in the management units, the road state management apparatus can display a plurality of pieces of information on the state of the surface of the road or information on the state under the surface of the road on a displaying device such as a display. This makes it possible to know the information on the state of the surface of the road or the information on the state under the surface of the road at a glance. Therefore, it is possible to easily judge whether there is a need to place an order for repair work of the road.

Specifically, by using display elements such as colors, patterns, figures, symbols, and letters for at least one information selected from the group including of flatness information of the road, crack information of the road, cavity information on a cavity under the surface of the road, adjunct information on an adjunct installed in the road, driving information of vehicles on the road, and repair history information of the road and by controlling displaying these kinds of information on a road on a road map based on the management units, it is possible to display a plurality of pieces of information on the state of the surface of the road or information on the state under the surface of the road in a manner to easily know them at a glance. For example, by displaying the flatness information, the crack information, and the adjunct information with a color, a pattern, and a symbol, respectively, such information as a color, a pattern, and a symbol is controlled to be displayed in a unified manner on a road on a road map divided by the management units, as illustrated in FIG. 28. As a result, by looking at information displayed on the road on this road map even at a glance where, for example, a color and a pattern are displayed in a certain management unit, it is possible to easily understand at a glance without any expert knowledge that the road section of this management unit has problems with flatness and cracking

As illustrate in FIG. 31, it may also be possible to display the information on the state of the surface of the road or the information on the state under the surface of the road based on the management units, while scrolling in the paper depth direction.

What is claimed is:

1. A non-transitory computer-readable recording medium having stored therein a road state management program for causing a computer to execute a process, the process comprising:
receiving at least one information selected from the group including of information on a state of a surface of a road and information on a state under the surface of the road;
distributing the received information to one or more management units of the road; and
extracting the plurality of pieces of the distributed information so as to be in order of time, wherein each of the distributed information is common place of the road.

2. The non-transitory computer-readable recording medium according to claim 1, wherein the road has lanes, and the one or more management units are set in each lane.

3. The non-transitory computer-readable recording medium according to claim 1, wherein the process further comprises:
controlling displaying the information extracted so as to be in order of time in each of the one or more management units.

4. The non-transitory computer-readable recording medium according to claim 1, wherein the process further comprises:
receiving a designation of the road;
making a demand to input the information on the state of the surface of the road or the information on the state under the surface of the road of a plurality of road sections obtained by dividing the road designated by units as according to the management units of the road;
associating the information input with the road sections corresponding to the plurality of road sections; and
storing the information associated in a memory part.

5. The non-transitory computer-readable recording medium according to claim 4, wherein the demand is presented to one or more addresses.

6. The non-transitory computer-readable recording medium according to claim 1, wherein the information on the state of the surface of the road or the information on the state under the surface of the road is selected from the group including of information on flatness of the road, information on a crack of the road, information on a cavity under the surface of the road, information on an adjunct installed in the road, information on an infrastructure facility under the surface of the road, information on a road sign of the road, information on vehicles passing the road, and information on repair history of the road.

7. A road state management apparatus, comprising a processor configured to execute a process, the process comprising:
receiving at least one information selected from the group including of information on a state of a surface of a road and information on a state under the surface of the road;
distributing the received information to one or more management units of the road; and
extracting the plurality of pieces of the distributed information so as to be in order of time, wherein each of the distributed information is common place of the road.

8. The road state management apparatus according to claim 7, wherein the road has lanes, and the one or more management units are set in each lane.

9. The road state management apparatus according to claim 7, further comprising:
a display control part configured to control displaying the information extracted so as to be in order of time in each of the one or more management units.

10. The road state management apparatus according to claim 7, wherein the process further comprises:
receiving a designation of the road;
making a demand to input the information on the state of the surface of the road or the information on the state under the surface of the road of a plurality of road sections obtained by dividing the road designated by units as according to the management units of the road;
associating the information input with the road sections corresponding to the plurality of road sections; and
storing the information associated in a memory part.

11. The road state management apparatus according to claim 10, wherein the demand is presented to one or more addresses.

12. A road state management method, comprising:
receiving at least one information selected from the group including of information on a state of a surface of a road and information on a state under a surface of the road, by a processor;
distributing the received information to one or more management units of the road, by the processor; and
extracting the plurality of pieces of the distributed information so as to be in order of time, by the processor, wherein each of the distributed information is common place of the road.

13. The road state management method according to claim 12, wherein the road has lanes, and the one or more management units are set in each lane.

14. The road state management method according to claim 12, further comprising:
controlling displaying the information extracted so as to be in order of time in each of the one or more management units.

15. The road state management method according to claim 12, wherein the process further comprises:
receiving a designation of the road;
making a demand to input the information on the state of the surface of the road or the information on the state under the surface of the road of a plurality of road sections obtained by dividing the road designated by units as according to the management units of the road;
associating the information input with the road sections corresponding to the plurality of road sections; and
storing the information associated in a memory part.

16. The road state management method according to claim 15, wherein the demand is presented to one or more addresses.
